(19) United States
(12) Patent Application Publication
(10) Pub. No.: US 2025/0193823 A1
(43) Pub. Date: Jun. 12, 2025

(54) POSITIONING REFERENCE UNIT SELECTION

(71) Applicant: Nokia Technologies Oy, Espoo (FI)

(72) Inventors: Stepan KUCERA, Munich (DE); Taylan SAHIN, Munich (DE); Diomidis MICHALOPOULOS, Munich (DE)

(73) Assignee: Nokia Technologies Oy, Espoo (FI)

(21) Appl. No.: 18/845,984

(22) PCT Filed: Feb. 21, 2023
(86) PCT No.: PCT/FI2023/050102

§ 371 Date: Sep. 11, 2024

(30) Foreign Application Priority Data
Mar. 11, 2022 (FI) 20225219

(51) Int. Cl. H04W 56/00; H04W 64/00; H04W 74/0833

(52) U.S. Cl. CPC H04W 56/0045; H04W 64/00; H04W 74/0833

(57) ABSTRACT

According to an example embodiment, a client device (100) comprises at least one processor and at least one memory including computer program code, the at least one memory and the computer program code being configured to, with the at least one processor, cause the client device to: obtain a plurality of timing advances for the client device from a plurality of network node devices (300) wherein a timing advance of the plurality of timing advances is associated with a network node device of the plurality of network node devices respectively; deliver the plurality of timing advances to a location management device; and receive, from the location management device, a positioning reference unit (301) selection indicating at least one positioning reference unit for the client device.

### TECHNICAL FIELD

The present disclosure generally relates to the field of wireless communications. In particular, the present disclosure relates to a client device, a location management device, related methods, and computer programs.

### BACKGROUND

A Positioning Reference Unit (PRU) at a known location can perform positioning measurements and report these measurements to a location server. In addition, the PRU can transmit Sounding reference signals (SRSs) to enable Transmission reception points (TRPs) to measure and report UL positioning measurements from PRUs at a known location. The PRU measurements can be compared by a location server with the measurements expected at the known PRU location to determine correction terms for other nearby target devices. The DL- and/or UL location measurements for other target devices can then be corrected based on the previously determined correction terms. PRUs can be used to enhance positioning accuracy of target client devices. PRUs located at known locations act as reference target client devices, such that their calculated position can be compared with the ground truth. The comparison of the known vs estimated location results in correction data which can be used for the location estimation process of other target client devices in the vicinity. Then, the correction data can be used for fine-tuning the location of the target client devices.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

An example embodiment of a client device comprises at least one processor and at least one memory comprising computer program code. The at least one memory and the computer program code are configured to, with the at least one processor, cause the client device to: obtain a plurality of timing advances for the client device from a plurality of network node devices wherein a timing advance of the plurality of timing advances is associated with a network node device of the plurality of network node devices respectively; deliver the plurality of timing advances to a location management device; and receive, from the location management device, a positioning reference unit selection indicating at least one positioning reference unit for the client device. The client device can, for example, assist the location management device in choosing the at least one positioning reference unit for the client device.

An example embodiment of a client device comprises means for performing: obtain a plurality of timing advances for the client device from a plurality of network node devices wherein a timing advance of the plurality of timing advances is associated with a network node device of the plurality of network node devices respectively; deliver the plurality of timing advances to a location management device; and receive, from the location management device, a positioning reference unit selection indicating at least one positioning reference unit for the client device.

In an example embodiment, alternatively or in addition to the above-described example embodiments, the at least one memory and the computer program code are further configured to, with the at least one processor, cause the client device to obtain the plurality of timing advances from the plurality of network node device using at least one small data transmission. The client device can, for example, efficiently obtain the plurality of timing advances from the plurality of network node device.

In another example embodiment, alternatively or in addition to the above-described example embodiments, the at least one memory and the computer program code are further configured to, with the at least one processor, cause the client device to transmit the plurality of timing advances to the location management device in a location request, in a response to a location request, or before a transmitting or receiving a location request. The client device can, for example, efficiently transmit the plurality of timing advances to the location management device.

In another example embodiment, alternatively or in addition to the above-described example embodiments, the at least one memory and the computer program code are further configured to, with the at least one processor, cause the client device to receive the positioning reference unit selection in assistance data. The client device can, for example, efficiently receive the positioning reference unit selection.

In another example embodiment, alternatively or in addition to the above-described example embodiments, the at least one memory and the computer program code are further configured to, with the at least one processor, cause the client device to obtain the plurality of timing advances from the plurality of network node devices using the at least one small data transmission by performing: transmitting at least one random access request message to the plurality of network node devices, wherein the at least one random access request message indicates that the at least one small data transmission is for timing advance acquisition; and receiving a plurality of random access response messages from the plurality of network node devices comprising the plurality of timing advances. The client device can, for example, efficiently obtain the plurality of timing advances using the random access procedure.

In another example embodiment, alternatively or in addition to the above-described example embodiments, the at least one random access request message further indicates that the plurality of network node devices are to abandon or stop random access channel procedure after transmitting the at least one random access response message. The client device can, for example, reduce overhead in the random access procedure.

In another example embodiment, alternatively or in addition to the above-described example embodiments, the at least one memory and the computer program code are further configured to, with the at least one processor, cause the client device to transmit identifications of the plurality of network node devices and/or beam indexes for the plurality of network node devices with the plurality of timing advances to the location management device. The client device can, for example, enable the location management device to utilize the identifications of the plurality of network node devices and/or the beam indexes with the plurality of timing advances in the positioning reference unit selection.

In another example embodiment, alternatively or in addition to the above-described example embodiments, one or more network node devices of the plurality of network node devices share same small data transmission resources, and wherein the at least one memory and the computer program code are further configured to, with the at least one processor, cause the client device to obtain timing advances for the one or more network node devices by performing a single small data transmission to the one or more network node devices. The client device can, for example, efficiently obtain timing advances from the one or more network node devices using a single small data transmission.

An example embodiment of a location management device comprises at least one processor and at least one memory comprising computer program code. The at least one memory and the computer program code are configured to, with the at least one processor, cause the location 30 management device to: obtain a first plurality of timing advances for a client device wherein a timing advance of the first plurality of timing advances is associated with a positioning reference unit of a plurality of positioning reference units; receive a second plurality of timing advances for the client device from the client device, wherein a timing advance of the second plurality of timing advances is associated with a network node device of a plurality of network node devices; select at least one positioning reference unit for the client device out of the plurality of positioning reference units based on the first plurality of timing advances and the second plurality of timing advances; and transmit the positioning reference unit selection to the client device. The location management device can, for example, efficiently select the at least one positioning reference unit for the client device.

An example embodiment of a location management device comprises means for performing: obtain a first plurality of timing advances for a client device wherein a timing advance of the first plurality of timing advances is associated with a positioning reference unit of a plurality of positioning reference units; receive a second plurality of timing advances for the client device from the client device, wherein a timing advance of the second plurality of timing advances is associated with a network node device of a plurality of network node devices; select at least one positioning reference unit for the client device out of the plurality of positioning reference units based on the first plurality of timing advances and the second plurality of timing advances; and transmit the positioning reference unit selection to the client device.

In an example embodiment, alternatively or in addition to the above-described example embodiments, the at least one memory and the computer program code are further configured to, with the at least one processor, cause the location management device to select the at least one positioning reference unit for the client device out of the plurality of positioning reference units by performing: determining a similarity of radio conditions associated with one or more network node devices of the plurality of network node devices between the client device and the at least one positioning reference unit and/or co-location of the client device and the at least one positioning reference unit based on the first plurality of timing advances and the second plurality of timing advances; and selecting the at least one positioning reference unit for the client device based on the similarity between the radio conditions and/or the co-location. The location management device can, for example, efficiently select the at least one positioning reference unit for the client device based on the similarity between the radio conditions and/or the co-location.

In another example embodiment, alternatively or in addition to the above-described example embodiments, the at least one memory and the computer program code are further configured to, with the at least one processor, cause the location management device to obtain the first plurality of timing advances by receiving the first plurality of timing advances from the plurality of positioning reference units. The location management device can, for example, efficiently obtain the first plurality of timing advances. An example embodiment of a method comprises: obtaining a plurality of timing advances for a client device from a plurality of network node devices, wherein a timing advance of the plurality of timing advances is associated with a network node device of the plurality of network node devices respectively; delivering the plurality of timing advances to a location management device; and receiving, from the location management device, a positioning reference unit selection indicating at least one positioning reference unit for the client device.

An example embodiment of a method comprises: obtaining a first plurality of timing advances for a client device wherein a timing advance of the first plurality of timing advances is associated with a positioning reference unit of a plurality of positioning reference units; receiving a second plurality of timing advances for the client device from the client device, wherein a timing advance of the second plurality of timing advances is associated with a network node device of a plurality of network node devices; selecting at least one positioning reference unit for the client device out of the plurality of positioning reference units based on the first plurality of timing advances and the second plurality of timing advances; and transmitting the positioning reference unit selection to the client device

An example embodiment of a computer program product comprises program code configured to perform, when the computer program product is executed on a computer: obtaining a plurality of timing advances for a client device from a plurality of network node devices, wherein a timing advance of the plurality of timing advances is associated with a network node device of the plurality of network node devices respectively; delivering the plurality of timing advances to a location management device; and receiving, from the location management device, a positioning reference unit selection indicating at least one positioning reference unit for the client device.

An example embodiment of a computer program product comprises program code configured to perform, when the computer program product is executed on a computer: obtaining a first plurality of timing advances for a client device wherein a timing advance of the first plurality of timing advances is associated with a positioning reference unit of a plurality of positioning reference units; receiving a second plurality of timing advances for the client device from the client device, wherein a timing advance of the second plurality of timing advances is associated with a network node device of a plurality of network node devices; selecting at least one positioning reference unit for the client device out of the plurality of positioning reference units based on the first plurality of timing advances and the second plurality of timing advances; and transmitting the positioning reference unit selection to the client device.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example embodiment of the subject matter described herein illustrating a client device;

FIG. 2 illustrates an example embodiment of the subject matter described herein illustrating a location management device;

FIG. 3 illustrates an example embodiment of the subject matter described herein illustrating positioning reference unit and client device locations;

FIG. 4 illustrates example embodiments of the subject matter described herein illustrating signaling diagrams;

FIG. 5 illustrates an example embodiment of the subject matter described herein illustrating a flow chart representation of a method; and

FIG. 6 illustrates an example embodiment of the subject matter described herein illustrating a flow chart representation of another method.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

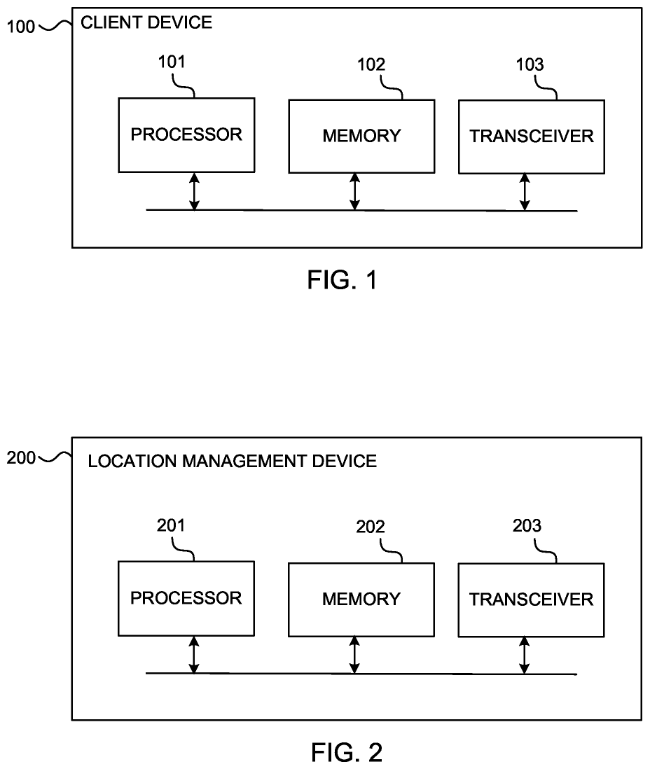

FIG. 1 is a block diagram of a client device 100 configured in accordance with an example embodiment.

The client device 100 may comprise one or more processors 101 and one or more memories 102 that comprise computer program code. The client device 100 may also comprise at least one transceiver 103, as well as other elements, such as an input/output module (not shown in FIG. 1), and/or a communication interface (not shown in FIG. 1).

According to an example embodiment, the at least one memory 102 and the computer program code are configured to, with the at least one processor 101, cause the client device 100 to obtain a plurality of timing advances for the client device 100 from a plurality of network node devices wherein a timing advance of the plurality of timing advances is associated with a network node device of the plurality of network node devices respectively.

Herein, a timing advance (TA) may also be referred to as TA value or similar.

The plurality of network node devices may comprise network node devices that serve the client device 100 and network node devices that do not serve and have not served the client device 100.

The plurality of network node devices may be embodied in, for example, base stations (BS). A base station may comprise, for example, a gNodeB (gNB) or any such device providing an air interface for client devices to connect to the wireless network via wireless transmissions.

The client device 100 may be further configured to deliver the plurality of timing advances to a location management device.

The client device 100 may be further configured to receive, from the location management device, a positioning reference unit selection indicating at least one positioning reference unit for the client device.

The location management device may be located in a core network (CN) while the client device 100 may be located in a radio access network (RAN). Thus, the client device 100 may deliver the TAs to the location management device via a serving network node device, such as a serving gNB. Similarly, the client device 100 may receive the positioning reference unit selection via the serving network node device.

According to an example embodiment, client device 100 is configured to obtain the plurality of timing advances from the plurality of network node devices using at least one small data transmission (SDT).

The SDT mechanism can allow the client device 100 to engage with any reachable target network node device in a given RAN Notification Area (RNA), which includes also neighbouring network node devices with whom said client device 100 had no prior communications. Accurate TA can be delivered from the target network node devices as part of any SDT communications.

According to an example embodiment, the client device 100 is configured to transmit the plurality of timing advances to the location management device in a location request, in a response to a location request, or before a transmitting or receiving a location request.

A location request may be a client-initiated request or a network-initiated request. The client device 100 can, for example, transmit the plurality of timing advances in response to a location request or prior to any requests, such as part of proactive signaling. For example, the PRUs can do so without having any active positioning session.

The location request may comprise, for example, a Mobile Originating-Location Request (MO-LR).

According to an example embodiment, the client device 100 is further configured to receive the positioning reference unit selection in assistance data. Assistance data (AD) may refer to specific type of data defined, for example, in a standard. The network may deliver positioning-related data to the UE in the AD. For example, the selected PRU can be indicated this way.

Although the client device 100 may be depicted to comprise only one processor 101, the client device 100 may comprise more processors. In an example embodiment, the memory 102 is capable of storing instructions, such as an operating system and/or various applications.

Furthermore, the processor 101 may be capable of executing the stored instructions. In an example embodiment, the processor 101 may be embodied as a multi-core processor, a single core processor, or a combination of one or more multi-core processors and one or more single core processors. For example, the processor 101 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 101 may be configured to execute hard-coded functionality. In an example embodiment, the processor 101 is embodied as an executor of software instructions, wherein the instructions may specifically configure the processor 101 to perform the algorithms and/or operations described herein when the instructions are executed.

The memory 102 may be embodied as one or more volatile memory devices, one or more non-volatile memory devices, and/or a combination of one or more volatile memory devices and non-volatile memory devices. For example, the memory 102 may be embodied as semiconductor memories (such as mask ROM, PROM (programmable ROM), EPROM (erasable PROM), flash ROM, RAM (random access memory), etc.).

When the client device 100 is configured to implement some functionality, some component and/or components of the client device 100, such as the at least one processor 101 and/or the memory 102, may be configured to implement this functionality. Furthermore, when the at least one processor 101 is configured to implement some functionality, this functionality may be implemented using program code comprised, for example, in the memory 102. For example, if the client device 100 is configured to perform an operation, the at least one memory 102 and the computer program code can be configured to, with the at least one processor 101, cause the client device 100 to perform that operation.

The client device 100 may comprise, for example, a mobile phone, a smartphone, a tablet computer, a smart watch, or any hand-held or portable device or any other apparatus, such as a vehicle, a robot, or a repeater. The client device 100 may also be referred to as a user equipment (UE) or similar.

Some terminology used herein may follow the naming scheme of 4G or 5G technology in its current form. However, this terminology should not be considered limiting, and the terminology may change over time. Thus, the following discussion regarding any example embodiment may also apply to other technologies.

FIG. 2 illustrates an example embodiment of the subject matter described herein illustrating a location management device 200.

The location management device 200 may comprise one or more processors 201 and one or more memories 202 that comprise computer program code. The location management device 200 may also comprise at least one transceiver 203, as well as other elements, such as an input/output module (not shown in FIG. 2), and/or a communication interface (not shown in FIG. 2).

The location management device 200 may, for example, correspond to the location management function (LMF). Any disclosure herein in relation to the location management device 200 may also apply to the LMF.

According to an example embodiment, the at least one memory 202 and the computer program code are configured to, with the at least one processor 201, cause the location management device 200 to obtain a first plurality of timing advances for a client device 100 wherein a timing advance of the first plurality of timing advances is associated with a positioning reference unit of a plurality of positioning reference units.

The location management device 200 may be further configured to receive a second plurality of timing advances for the client device 100 from the client device 100, wherein a timing advance of the second plurality of timing advances is associated with a network node device of a plurality of network node devices.

The location management device 200 may be further configured to select at least one positioning reference unit for the client device 100 out of the plurality of positioning reference units based on the first plurality of timing advances and the second plurality of timing advances.

The location management device 200 may be further configured to transmit the positioning reference unit selection to the client device.

The client device 100 and the location management device 200 can enable efficient PRU selection based on similarity of radio conditions with respect to the client device 100 to ensure representative measurements of differential corrections. Since the PRU correction data should improve the accuracy of the positioning of the client device 100, the PRU and the client device 100 should be experiencing the same radio conditions with respect to, for example, a given network node device. Similarly, to be able to apply the same correction data for the client device 100 as that of the PRU, it should be ensured that the client device 100 and the PRU are measured by the same set of transmission/reception points (TRPs) and with same conditions (e.g., LoS, BW, measurement capability, etc.). This means that the PRU and the client device 100 should have similar measurement capabilities and experience the same or similar radio conditions.

The client device 100 and the location management device 200 can also enable fast PRU selection and its activation without extra delay or overhead. The PRU selection should be done in a short time and with minimal overhead considering the latency constraint and network efficiency targets of enhanced NR positioning. This becomes important in mobile scenarios and low-latency positioning applications, where the (accurate) position of a client device 100 should be estimated within short time. Typical examples of such low latency applications are automotive ones.

According to an example embodiment, the location management device 200 is further configured to select the at least one positioning reference unit for the client device out of the plurality of positioning reference units by performing: determining a similarity of radio conditions associated with one or more network node devices of the plurality of network node devices between the client device 100 and the at least one positioning reference unit and/or co-location of the client device and the at least one positioning reference unit based on the first plurality of timing advances and the second plurality of timing advances, and selecting the at least one positioning reference unit for the client device 100 based on the similarity between the radio conditions and/or the co-location.

Similarity of radio condition can be compared by, for example, comparing vectors of measured signal strength and/or timing advances. For example, a maximum distance of the compared vectors can be used.

A comparison of TAs is a quick and efficient approach to determining similarity of radio conditions as well as UE-PRU co-location. The reason is that the basic unit for TA adjustment is typically the sampling period, 32.55 ns for the shortest FR1 cyclic prefix. Multiplied by speed of light, one obtains 10 m resolution for PRU selection in line-of-sight conditions.

Although the location management device 200 may be depicted to comprise only one processor 201, the location management device 200 may comprise more processors. In an example embodiment, the memory 202 is capable of storing instructions, such as an operating system and/or various applications.

Furthermore, the processor 201 may be capable of executing the stored instructions. In an example embodiment, the processor 201 may be embodied as a multi-core processor, a single core processor, or a combination of one or more multi-core processors and one or more single core processors. For example, the processor 201 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 201 may be configured to execute hard-coded functionality. In an example embodiment, the processor 201 is embodied as an executor of software instructions, wherein the instructions may specifically configure the processor 201 to perform the algorithms and/or operations described herein when the instructions are executed.

The memory 202 may be embodied as one or more volatile memory devices, one or more non-volatile memory devices, and/or a combination of one or more volatile memory devices and non-volatile memory devices. For example, the memory 202 may be embodied as semiconductor memories (such as mask ROM, PROM (programmable ROM), EPROM (erasable PROM), flash ROM, RAM (random access memory), etc.).

When the location management device 200 is configured to implement some functionality, some component and/or components of the location management device 200, such as the at least one processor 201 and/or the memory 202, may be configured to implement this functionality. Furthermore, when the at least one processor 201 is configured to implement some functionality, this functionality may be implemented using program code comprised, for example, in the memory 202. For example, if the location management device 200 is configured to perform an operation, the at least one memory 202 and the computer program code can be configured to, with the at least one processor 201, cause the location management device 200 to perform that operation.

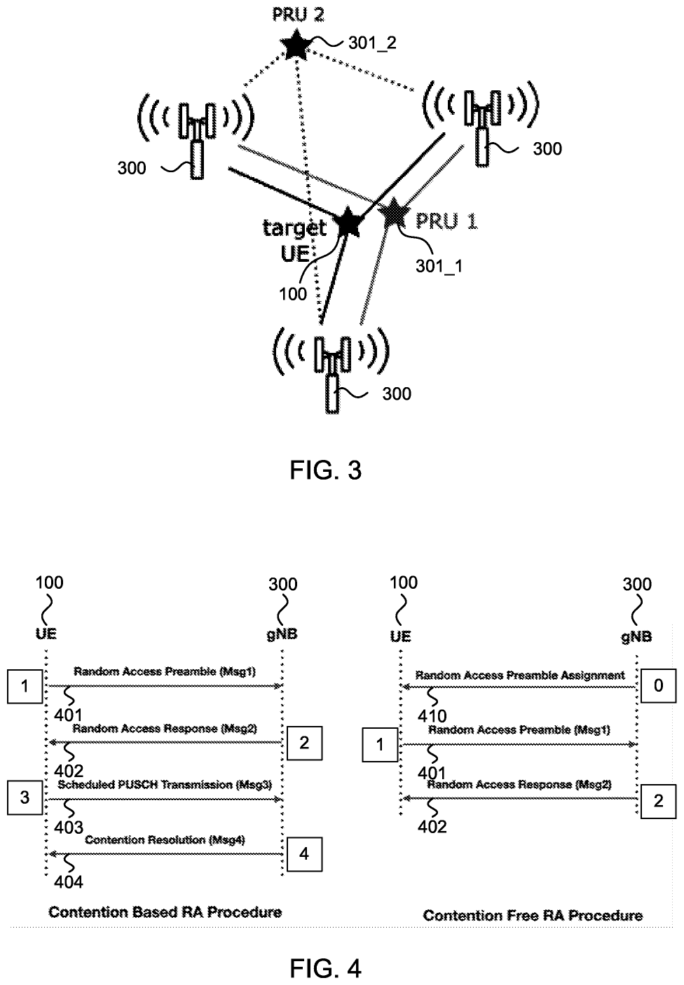

FIG. 3 illustrates an example embodiment of the subject matter described herein illustrating positioning reference unit and client device locations.

The client device 100 can establish the plurality of timing advances (TAs) to several neighbouring network node devices 300, such as gNBs, by using the Small Data Transmission mechanism. Details addressing both RRC_CONNECTED and RRC_INACTIVE scenarios are disclosed herein.

The SDT mechanism can allow client devices 100 to engage with any reachable target network node device 300 in a given RNA (group of cells pre-defined for paging purposes), which comprises also neighbouring network node devises 300 with whom said client device 100 had no prior communications (so-called “SDT Message 1/A”).

Accurate TAs can be delivered from the target network node device 300 as a part of any SDT communications (so-called “SDT Message 2/B”).

The client device 100 can communicate these TAs to the location management device 200, for example as a part of the location request such as MO-LR, for subsequent PRU selection and activation. For example, PRU identity is delivered as part of assistance data upon positioning session establishment.

As illustrated in the example embodiment of FIG. 3, similarity of TAs can allow detecting co-location. Unlike the second PRU 301_2, the first PRU 301_1 exhibits TAs, visualized geometrically as connecting lines, to neighbouring gNBs 300 that are comparable to those of the target client device 100.

The location management device 200 can thus exploit the obtained TA information to select appropriate PRU(s) to improve the accuracy of the location estimate of the client device 100. The selection can be based on, for example, the similarity of the TA information.

FIG. 4 illustrates example embodiments of the subject matter described herein illustrating signaling diagrams.

The example embodiments of FIG. 4 illustrate procedures using which the client device 100 can obtain the TAs using SDT. A contention based random access (RA) procedure is illustrated in the left example embodiment of FIG. 4 and a contention free RA procedure is illustrated in the right example embodiment of FIG. 4.

According to an example embodiment, the client device 100 is further configured to obtain the plurality of timing advances from the plurality of network node devices 300 using the at least one small data transmission by performing: transmitting at least one random access request message 401 to the plurality of network node devices 300, wherein the at least one random access request message 401 indicates that the at least one small data transmission is for timing advance acquisition and receiving a plurality of random access response messages 402 from the plurality of network node devices 300 comprising the plurality of timing advances.

According to an example embodiment, the at least one random access request message 401 further indicates that the plurality of network node devices 300 are to abandon or stop random access channel procedure after transmitting the at least one random access response message 402.

The client device 100 can transmit an initial Random Access Request message 401 to the network node device 300. The initial Random Access Request message 401 can comprise an indication that the purpose of the SDT transmission is only to obtain a valid TA. For example, an appropriate flag in the message 401 can be raised. As part of the Random Access Response message 402, the network node device 300 can deliver the TA, determined with sampling period accuracy. The client device 100 may not need to reach all neighbouring network node device 300 to permit TA-based multilateration, only few surrounding ones may be sufficient. Even two neighbouring network node devices 300 in addition to the camped-on network node device 300 for triangulation purposes may be sufficient.

The initial message 401 can comprise an indication that subsequent steps 403, 404 of the RACH procedure are not of interest to the client device 100, but that only a TA is required, and that the network node device 300 should abandon the procedure after the delivery of its response message 402 without waiting for the expiry of standardized timers setting the client device response time deadline.

In contention free RA procedure, the procedure random access preamble 401 and the random access response 402 may be as disclosed above. The contention free RA procedure can be initiated by the network node device 300 transmitting a random access preamble assignment 410 as illustrated in the right example embodiment of FIG. 4.

According to an example embodiment, the client device 100 is further configured to transmit identifications of the plurality of network node devices 300 and/or beam indexes for the plurality of network node devices 300 with the plurality of timing advances to the location management device.

Each TA may be associated with an identification of a network node device and/or with a beam index.

The client device 100 can then deliver measured TAs together with gNB ID, such as Physical Cell Identifier (PCI), to the location management device 200, for example as a part of a positioning request, such as Mobile Originating-Location Request (MO-LR), or by using extended/adapted Enhanced Cell-ID (ECID) reporting mechanism. gNB beam index can be also added for angle-of-arrival (AoA) enhancements of the TA info.

The location management device 200 can then compare the vector of measured TAs with a database of PRU TAs. The PRUs can obtain and report their own TAs in a similar fashion as the client device 100.

According to an example embodiment, one or more network node devices of the plurality of network node devices 300 share same small data transmission resources, and wherein the at least one memory and the computer program code are further configured to, with the at least one processor, cause the client device 100 to obtain timing advances for the one or more network node devices by performing a single small data transmission to the one or more network node devices.

In some example embodiments, the one or more network node devices may be in the same RNA.

gNBs in the same RNA can share the same pre-defined SDT resources to permit a single SDT “broadcast” transmission by the client device 100, or by a PRU, to all target gNBs at the same time and with a low overhead. This option can require some coordination by the gNB SDT random access response 402, such as random backoff, PCI-based ordering, or central pre-configuration, to deliver TAs in a sequential non-conflicting manner.

According to an example embodiment, the location management device 200 is configured to obtain the first plurality of timing advances by receiving the first plurality of timing advances from the plurality of positioning reference units.

If the PRUs are in inactive mode, then they can first measure their own TAs by using SDT similarly to the target client device 100 and then report them to the location management device 200 using, for example, LTE positioning protocol (LPP) or any other protocol, such as Radio Resource Control (RRC)+NR Positioning Protocol A (NRPPa) with the help of the gNB as intermediary.

In RRC connected mode, the PRUs can obtain the TA information from the serving gNB directly via the standardized medium access control (MAC) control element (CE) and obtain the TA with neighbouring cells via SDT. Thus, the SDT may be needed for all PRUs/UEs when engaging with neighbouring cells. However, the PRU TAs to the neighbouring gNBs can be substituted by equivalent information, for example SRS delay measured during positioning procedures. The location management device 200 can have full access to such information.

To ensure resource efficiency and reduce signaling overhead, gNBs in the same RNA can reserve a given RACH resource for all gNBs so that the same random access request message 401 from the a client device 100 can trigger multiple gNBs. Power can be adapted to this end to ensure sufficient range. As mentioned above however, only few representative client devices 100 shall be reached, there is no need for exhaustive measurements with as many gNBs are possible for power and latency reasons. The gNBs may have to reply with their random access responses 402 in a non-colliding manner. For example, random backoff or preconfigured order (eg, based on PCI value) can be used to order the gNB transmissions in time.

The procedure can be similar in RRC_CONNECTED mode, except that the client device 100 can require measurement gaps from the serving network node device to engage in SDT with neighbouring network node devices. So-called autonomous gaps for positioning measurements can be used as they are sufficiently long (10/20 ms). Standard Radio resource measurement (RRM) measurement gaps could be used as well for SDT exchange assuming the target network node device responds within the duration of the measurement gap. In scenarios, in which the TA can be reported to the serving network node device, client device 100 could report measured TAs to the serving network node device which could then in turn forward this information to the location management device 200 via extended/adapted NRPPa.

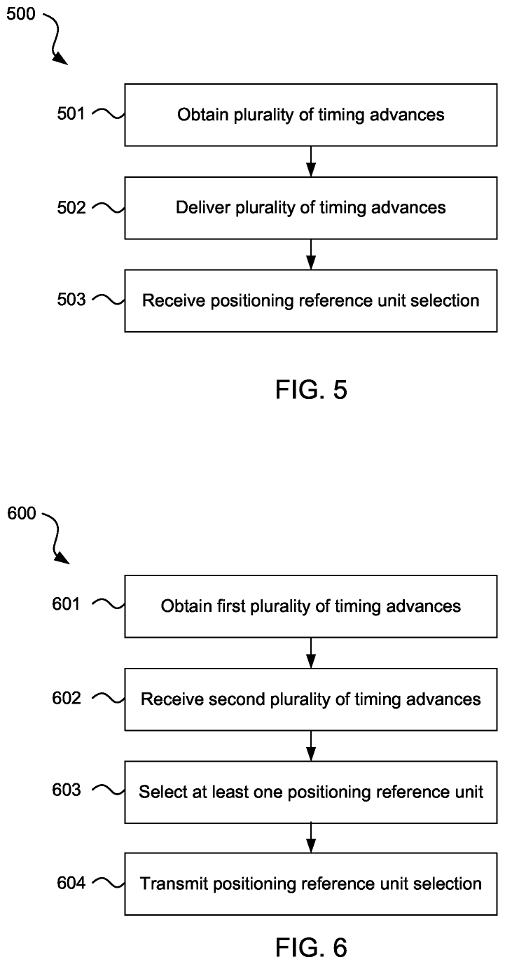

FIG. 5 illustrates an example embodiment of the subject matter described herein illustrating a flow chart representation of a method.

According to an example embodiment, the method 500 comprises obtaining 501 a plurality of timing advances for a client device 100 from a plurality of network node devices 300, wherein a timing advance of the plurality of timing advances is associated with a network node device of the plurality of network node devices 300 respectively.

The method 500 may further comprise delivering 502 the plurality of timing advances to a location management device 200.

The method 500 may further comprise receiving 503, from the location management device 200, a positioning reference unit selection indicating at least one positioning reference unit for the client device 100.

The method 500 may be performed by, for example, the client device 100.

FIG. 6 illustrates an example embodiment of the subject matter described herein illustrating a flow chart representation of another method.

According to an example embodiment, the method 600 comprises obtaining 601 a first plurality of timing advances for a client device 100 wherein a timing advance of the first plurality of timing advances is associated with a positioning reference unit of a plurality of positioning reference units.

The method 600 may further comprise receiving 602 a second plurality of timing advances for the client device 100 from the client device 100, wherein a timing advance of the second plurality of timing advances is associated with a network node device of a plurality of network node devices 300.

The method 600 may further comprise selecting 603 at least one positioning reference unit for the client device 100 out of the plurality of positioning reference units based on the first plurality of timing advances and the second plurality of timing advances.

The method 600 may further comprise transmitting 604 the positioning reference unit selection to the client device 100.

The method 600 may be performed by, for example, the location management device 200.

An apparatus may comprise means for performing any aspect of the method(s) described herein. According to an example embodiment, the means comprises at least one processor, and memory comprising program code, the at least one processor, and program code configured to, when executed by the at least one processor, cause performance of any aspect of the method.

The functionality described herein can be performed, at least in part, by one or more computer program product components such as software components. According to an example embodiment, the network node device 100 comprises a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed example embodiments without departing from the spirit or scope of this specification.

1. A client device, comprising:
at least one processor; and
at least one memory including computer program code;
the at least one memory and the computer program code configured to, with the at least one processor, cause the client device to:
obtain a plurality of timing advances for the client device from a plurality of network node devices wherein a timing advance of the plurality of timing advances is associated with a network node device of the plurality of network node devices respectively;
deliver the plurality of timing advances to a location management device; and
receive, from the location management device, a positioning reference unit selection indicating at least one positioning reference unit for the client device.

2. The client device according to claim 1, wherein the at least one memory and the computer program code are further configured to, with the at least one processor, cause the client device to obtain the plurality of timing advances from the plurality of network node device using at least one small data transmission.

3. The client device according to claim 1, wherein the at least one memory and the computer program code are further configured to, with the at least one processor, cause the client device to transmit the plurality of timing advances to the location management device in a location request, in a response to a location request, or before a transmitting or receiving a location request.

4. The client device according to claim 1, wherein the at least one memory and the computer program code are further configured to, with the at least one processor, cause the client device to receive the positioning reference unit selection in assistance data.

5. The client device according to claim 1, wherein the at least one memory and the computer program code are further configured to, with the at least one processor, cause the client device to obtain the plurality of timing advances from the plurality of network node devices using the at least one small data transmission by performing:
transmitting at least one random access request message to the plurality of network node devices, wherein the at least one random access request message indicates that the at least one small data transmission is for timing advance acquisition; and
receiving a plurality of random access response messages from the plurality of network node devices (300) comprising the plurality of timing advances.

6. The client device according to claim 5, wherein the at least one random access request message further indicates that the plurality of network node devices are to abandon or stop random access channel procedure after transmitting the at least one random access response message.

7. The client device according to claim 1, wherein the at least one memory and the computer program code are further configured to, with the at least one processor, cause the client device to transmit identifications of the plurality of network node devices and/or beam indexes for the plurality of network node devices with the plurality of timing advances to the location management device.

8. The client device according to claim 1, wherein one or more network node devices of the plurality of network node devices share same small data transmission resources, and wherein the at least one memory and the computer program code are further configured to, with the at least one processor, cause the client device to obtain timing advances for the one or more network node devices by performing a single small data transmission to the one or more network node devices.

9. A location management device, comprising:
at least one processor; and
at least one memory including computer program code;
the at least one memory and the computer program code configured to, with the at least one processor, cause the location management device to:
obtain a first plurality of timing advances for a client device wherein a timing advance of the first plurality of timing advances is associated with a positioning reference unit of a plurality of positioning reference units;
receive a second plurality of timing advances for the client device from the client device, wherein a timing advance of the second plurality of timing advances is associated with a network node device of a plurality of network node devices;
select at least one positioning reference unit for the client device out of the plurality of positioning reference units based on the first plurality of timing advances and the second plurality of timing advances; and
transmit the positioning reference unit selection to the client device.

10. The location management device according to claim 9, wherein the at least one memory and the computer program code are further configured to, with the at least one processor, cause the location management device to select the at least one positioning reference unit for the client device out of the plurality of positioning reference units by performing:
determining a similarity of radio conditions associated with one or more network node devices of the plurality of network node devices between the client device and the at least one positioning reference unit and/or co-location of the client device (100) and the at least one positioning reference unit based on the first plurality of timing advances and the second plurality of timing advances; and
selecting the at least one positioning reference unit for the client device based on the similarity between the radio conditions and/or the co-location.

11. The location management device according to claim 9, wherein the at least one memory and the computer program code are further configured to, with the at least one processor, cause the location management device to obtain the first plurality of timing advances by receiving the first plurality of timing advances from the plurality of positioning reference units.

12. A method, comprising:
obtaining a plurality of timing advances for a client device from a plurality of network node devices, wherein a timing advance of the plurality of timing advances is associated with a network node device of the plurality of network node devices respectively;
delivering the plurality of timing advances to a location management device; and
receiving, from the location management device, a positioning reference unit selection indicating at least one positioning reference unit for the client device.

13-15. (canceled)
